(19) United States
(12) Patent Application Publication
(10) Pub. No.: US 2026/0188542 A1
(43) Pub. Date: Jul. 2, 2026

(54) METHOD FOR FABRICATING HEAVY-LOAD HIGH-CURRENT 10KV LIGHTNING ARRESTER

(71) Applicant: ELECTRIC POWER RESEARCH INSTITUTE, CHINA SOUTHERN POWER GRID, Guangzhou, Guangdong (CN)

(72) Inventors: Shangmao HU, Guangzhou, Guangdong (CN); Minchuan LIAO, Guangzhou, Guangdong (CN); Gang LIU, Guangzhou, Guangdong (CN); Lei JIA, Guangzhou, Guangdong (CN); Lu QU, Guangzhou, Guangdong (CN); Taishan HU, Guangzhou, Guangdong (CN); Xipeng CHEN, Guangzhou, Guangdong (CN); Huaifei CHEN, Guangzhou, Guangdong (CN); Qi MEI, Guangzhou, Guangdong (CN); Cheng YAO, Guangzhou, Guangdong (CN); Hao LIU, Guangzhou, Guangdong (CN); Ruihan QI, Guangzhou, Guangdong (CN); Yongcong WU, Guangzhou, Guangdong (CN); Hansheng CAI, Guangzhou, Guangdong (CN)

(73) Assignee: ELECTRIC POWER RESEARCH INSTITUTE, CHINA SOUTHERN POWER GRID, Guangzhou, Guangdong (CN)

(21) Appl. No.: 18/837,898

(22) PCT Filed: Nov. 24, 2023
(86) PCT No.: PCT/CN2023/133918

§ 371 Date: Aug. 13, 2024

(30) Foreign Application Priority Data
Jun. 12, 2023 (CN) 202310693076.6

(51) Int. Cl. H01C 1/084; H01C 1/024; H01C 7/12; H01C 17/02; H01C 17/28

(52) U.S. Cl. CPC H01C 1/084; H01C 1/024; H01C 7/12; H01C 17/02; H01C 17/28

(57) ABSTRACT

A method for fabricating heavy-load high-current 10 kV lightning arrester, comprising: obtaining a target valve plate from candidate valves through a direct-current reference-voltage test, where the target valve plate meets that: a surge current capacity is greater than or equal to 100 kA, a square-wave current capacity is greater than 600 A, a residual voltage under 10 kA surge current is less than or equal to 45 kV, and repetitive charge transfer rating is greater than or equal to 0.8 C; and assembling a glass-epoxy layer and an electrode pair into a sealed shell inside which the target valve plate is disposed, where the target valve plate is electrically connected to a first electrode and a second electrode in the electrode pair to form the heavy-load high-current 10 kV lightning arrester. An issue of frequent faults of lightning arresters in conventional technology is addressed.

This application claims the priority of the Chinese Patent Application No. 202310693076.6, titled “METHOD FOR FABRICATING HEAVY-LOAD HIGH-CURRENT 10 KV LIGHTNING ARRESTER”, filed on Jun. 12, 2023 with the China National Intellectual Property Administration, which is incorporated herein by reference in its entirety.

### FIELD

The present disclosure relates to the technical field of lightning arresters, and in particular to a method for fabricating a heavy-load high-current 10 kV lightning arrester.

### BACKGROUND

Power grids in southern China are in tropical and subtropical areas, which surfer from frequent and long-lasting lightning hazards. On a basis of typical 10 kV power distribution networks and parameters of D3 (of which a diameter ranging from 30 mm to 35 mm), D4 (of which a diameter ranging from 40 mm to 45 mm) and D5 (of which a diameter ranging from 50 mm to 55 mm) series varistor arresters, operations of the arresters are computed and analyzed under conditions in which wires and electric poles/towers are impacted by lightning current with different waveforms and different amplitude and induction lighting strokes. Thereby, a residual voltage, a current, a discharge current, power absorption, and an energy overload probability are obtained for various lightning arresters under various lightning-strike faults. It is particularly revealed that that the D3 series varistor arresters are rather inadequate in current capacity, which is a main cause of their short service life and high damage rates. Power absorption of a single D3 series varistor arrester ranges approximately from 20 kJ to 25 kJ.

At present, heavy-load 10 kV transformer pedestals generally utilize conventional YH5WS-17/50 type lightning arresters in the power grids of southern China. When lightning strikes a wire directly, the discharge current usually exceeds 5 kA, and the residual voltage may reach 60 kV to 80 kV, which results in a low coefficient of insulation coordination between the arrester and the distribution transformer. Even worse, it may even exceed an insulation level of the distribution transformer, i.e., the residual voltage is likely to exceed 75 kV (or 60 kV), which is a limitation specified for voltage tolerance of the 10 kV distribution transformers under lighting strokes in GB/T 50064-2014 “Specifications for Designing Overvoltage Protection and Insulation Coordination of Alternating-current Electric Devices”. Excessively high residual voltage would induce safe risks into operation of the transformers. A square-wave current capacity of conventional lightning arresters is only 150 A, while their maximum surge current capacity is 65 kA.

Numerous lightning arresters are widely distributed in the distribution networks of the power grids. Preventive tests on operation conditions of the lightning arresters would consume a large amount of labor, materials, and money, and currently the arresters would not be handled unless an accident has occurred, which is not good for normal operation of the power grids. Faults of the lightning arrester has profound influence on reliability of power supply. During a period from year 2008 to 2018, faults are frequently detected in the lightning arresters of the distribution networks frequently, which influences 6.3 million lightning arresters in total. Huge costs are required for replacement of all the faulty lightning arresters.

### SUMMARY

Embodiments of the present disclosure mainly provides a method for fabricating a heavy-load high-current 10 kV lightning arrester. Addressed is at least an issue of frequent faults of lightning arresters in conventional technology.

In order to achieve the above objective, a method for fabricating heavy-load high-current 10 kV lightning arrester is provided according to a first aspect of embodiments of the present disclosure. The method comprises: obtaining a target valve plate from candidate valves through a direct-current reference-voltage test, where the target valve plate meets that: a surge current capacity is greater than or equal to 100 kA, a square-wave current capacity is greater than 600 A, a residual voltage under 10 kA surge current is less than or equal to 45 kV, and repetitive charge transfer rating is greater than or equal to 0.8 C; and assembling a glass-epoxy layer and an electrode pair into a sealed shell inside which the target valve plate is disposed, where the target valve plate is electrically connected to a first electrode and a second electrode in the electrode pair to form the heavy-load high-current 10 kV lightning arrester.

In an embodiment, assembling the glass-epoxy layer and the electrode pair into the sealed shell inside which the target valve plate is disposed comprises: assembling the glass-epoxy layer, the electrode pair, and the target valve plate into a core component, where the target valve plate is connected to the second electrode and the first electrode, and the glass-epoxy layer is in contact with the target valve plate; coating the core component with a coupling agent and drying the coated core component; preheating the coated and dried core component to obtain a preheated core component; obtaining an outer sleeve mold of the preheated core component through vulcanizing, where the vulcanizing is tested and meets a temperature requirement on the outer sleeve mold; laying a silicone rubber at an inner surface of the outer sleeve mold, and attaching the silicone rubber at the inner surface of the outer sleeve mold to the preheated core component through pressure molding, to obtain an outer sleeve made of the silicone rubber; and sealing the outer sleeve and the preheated core component to form the heavy-load high-current 10 kV lightning arrester.

In an embodiment, assembling the glass-epoxy layer, the electrode pair, and the target valve plate into the core component comprises: mounting the target valve plate in a cavity enclosed by a glass-epoxy cylinder, where the glass-epoxy layer is shaped into the glass-epoxy cylinder; and mounting the first electrode and the second electrode on two opposite side walls, respectively, of the glass-epoxy cylinder through rotation to connect the target valve plate to the second electrode and the first electrode to form the core component.

In an embodiment, sealing the outer sleeve and the preheated core component to form the heavy-load high-current 10 kV lightning arrester comprises: connecting the first electrode and the second electrode to the glass-epoxy cylinder through screw threads; applying an adhesive, which is curable under room-temperature, onto the screw threads at a position at which the first electrode and the second electrode are connected to the glass-epoxy cylinder; and disposing a sealing ring on a contact surface between the electrode pair and the glass-epoxy layer to form the sealed shell, where the sealed shell and the target valve plate form the heavy-load high-current 10 kV lightning arrester.

In an embodiment, after sealing the outer sleeve and the preheated core component to form the heavy-load high-current 10 kV lightning arrester, the method further comprises: performing a test on the heavy-load high-current 10 kV lightning arrester to obtain an initial direct-current reference voltage and an initial leakage current, where the test is for obtaining a direct-current reference voltage and a leakage current, and the initial leakage current is the leakage current of the heavy-load high-current 10 kV lightning arrester under three quarters of the initial direct-current reference voltage; boiling the heavy-load high-current 10 kV lightning arrester in salty water for predetermined duration to obtain a to-be-tested heavy-load high-current 10 kV lightning arrester; performing another test on the to-be-tested heavy-load high-current 10 kV lightning arrester to obtain a to-be-verified direct-current reference voltage, a to-be-verified leakage current, and a partial discharge measurement of the to-be-tested heavy-load high-current 10 kV lightning arrester, where the another test is for obtaining the direct-current reference voltage, the leakage current, and magnitude of partial discharge, where the to-be-verified leakage current is the leakage current of the to-be-tested heavy-load high-current 10 kV lightning arrester under three quarters of the initial direct-current reference voltage, and the partial discharge measurement is the magnitude of partial discharge of the to-be-tested heavy-load high-current 10 kV lightning arrester under 1.05 times of the initial direct-current reference voltage; and determining that the sealing is successful in response to a first deviation being less than or equal to 5% of the initial direct-current reference voltage, a second deviation being less than or equal to 20 μA, and the magnitude of partial discharge being less than or equal to 10 pC, where the first deviation is an absolute difference between the initial direct-current reference voltage and the to-be-verified direct-current reference voltage, and the second deviation is an absolute difference between the to-be-verified leakage current and the initial leakage current.

In an embodiment, after mounting the target valve plate in the cavity enclosed by the glass-epoxy cylinder and before mounting the first electrode and the second electrode on two opposite side walls, respectively, of the glass-epoxy cylinder, the method further comprises: mounting a conical spring between a target side wall and the target valve plate, where the conical spring is configured to hold the valve plate through elastic force, and the target side wall is a side wall on which the first electrode is mounted.

In an embodiment, the conical spring is electrically conductive.

In an embodiment, after mounting the conical spring between the target side wall and the target valve plate, the method further comprises: wrapping the conical spring by using multiple conductive strips.

In an embodiment, after connecting the first electrode and the second electrode to the glass-epoxy cylinder through screw threads, applying the adhesive, which is curable under room-temperature, onto the screw threads at the position at which the first electrode and the second electrode are connected to the glass-epoxy cylinder, and disposing the sealing ring on the contact surface between the electrode pair and the glass-epoxy layer to form the sealed shell, the method further comprises: providing multiple protrusions on the sealed shell.

In an embodiment, the target valve plate comprises at least one valve plate, and a specification of the at least one valve plate is D52 (of which a diameter is 52 mm).

Herein the method for fabricating the high-current lightning arrester is provided according to technical solutions of the present disclosure. First, the direct-current reference voltage test is performed on the candidate valve plates to obtain the target valve plate. The target valve plate meets that the surge current capacity is greater than or equal to 100 kA, the square-wave current capacity is greater than 600 A, the residual voltage under 10 kA surge current is less than or equal to 45 kV, and the repetitive charge transfer rating is greater than or equal to 0.8 C. A combined surge-current test is performed on the valve plate of the lightning arrester according to the international standard IEC 60099-4:2014, and the valve plate shall pass the combined surge-current test, i.e., 4/10 μs surge current capacity under 100 kA, 8/20 μs lightning impact residual voltage under 40 kA, 2 ms square-wave current capacity under 600 A, and 8/20 μs lightning impact residual voltage under 40 kA. Thereby, the to-be-assembled valve plate is selected. The glass-epoxy layer and the electrode pair are assembled into the sealed shell, and the valve plate is disposed inside the sealed shell. The target valve plate is electrically connected to the first electrode and the second electrode in the electrode pair to form the heavy-load high-current 10 kV lightning arrester. In such method, the manufactured heavy-load high-current 10 kV lightning arrester is considered to qualified only when meeting the following requirements. Four 4/10 μs surge current tests and a repetitive charge transfer test (20 times criterion) are performed, and the repetitive charge transfer rating shall meet the 0.8 C requirement and variations of the lightning impact residual voltage shall not exceed 5%. A 2 ms square wave test (18 periods) is performed, and the square-wave current capacity shall meet the 600 A requirement. The lightning arrester shall further pass a bending load test under 400N for 18 seconds without being damaged. Moreover, the heavy-load high-current 10 kV lightning arrester dissipates heat, which is generated by the target valve plate, via the glass-epoxy layer. High heat conduction efficiency of the glass-epoxy improves surge endurance of the lightning arrester against the lightning strokes. A fault rate is reduced, and the issue of frequent faults of lightning arresters in conventional technology is addressed.

### BRIEF DESCRIPTION OF THE DRAWINGS

FIG. 1 illustrates a schematic flowchart of a method for fabricating a heavy-load high-current 10 kV lightning arrester according to an embodiment of the present disclosure.

FIG. 2 illustrates a schematic structural diagram of a heavy-load high-current 10 kV lightning arrester according to an embodiment of the present disclosure.

### REFERENCE NUMERALS

| | | | |
|---|---|---|---|
| 10: | First electrode, | 50: | Conical spring, |
| 20: | Second electrode, | 60: | Outer sleeve, |
| 30: | Valve plate, | 70: | EPDM (Ethylene Propylene Diene |
| | | | Monomer) sealing ring, |
| 40: | Glass-epoxy layer, | 80: | Aluminum buffer block. |

### DETAILED DESCRIPTION OF THE EMBODIMENTS

Embodiments of the present disclosure and features in the embodiments may be combined with each other when there is no conflict. Hereinafter the present disclosure is described in detail in conjunction with the embodiments and with reference to the drawings.

Hereinafter technical solutions of the embodiments of the present disclosure are described clearly and completely in conjunction with the drawings of the embodiments of the present disclosure to enable those skilled in the art to better understand these solutions. Apparently, the embodiments described below are only some, rather than all, embodiments of the present disclosure. Any other embodiments obtained by those skilled in the art based on the embodiments in the present disclosure without any creative effort shall fall within the protection scope of the present disclosure.

Herein the terms “first”, “second”, and the like, in the description, claims, and the drawings are intended for distinguishing similar objects rather than to indicating a specific sequence or order. Objects modified by these terms are interchangeable in proper circumstances when illustrating embodiments of the present disclosure. Moreover, the terms “include (comprise)”, “have”, and any variants thereof are intended for covering non-exclusive inclusion. For example, a process, method, system, product, or device that includes a list of steps or units is not necessarily limited to the expressly listed steps or units but may include another step or unit, which is not expressly listed or is inherent to the process, method, product, or device.

When an element (such as a layer, a film, an area, or a substrate) is described to be “on” another element, the element may be directly on the other element, or an intermediate element may exist between the two. Moreover, when an element is described to be “connected” to another element in the specification or the claims, the element may be “directly connected” to the other element or may be “connected” to the other element via a third element.

As described in the background, faults occur frequently in conventional lightning arrester. In order to address at least the above issue, a method for fabricating a heavy-load high-current 10 kV lightning arrester is provided according to embodiments of the present disclosure.

Hereinafter the technical solutions in embodiments of the present application are described clearly and completely in conjunction with the drawings.

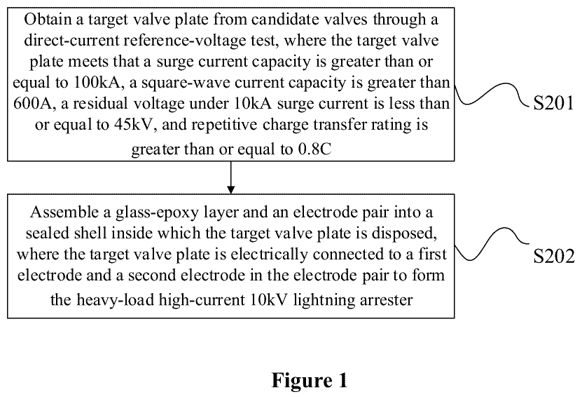

In an embodiment, a method for fabricating a heavy-load high-current 10 kV lightning arrester. As shown in FIG. 1, the method comprises steps S101 and S102.

In step S101, a target valve plate is obtained from candidate valves through a direct-current reference-voltage test. The target valve plate meets that a surge current capacity is greater than or equal to 100 kA, a square-wave current capacity is greater than 600 A, a residual voltage under 10 kA surge current is less than or equal to 45 kV, and repetitive charge transfer rating is greater than or equal to 0.8 C.

In an embodiment, a valve plate for the heavy-load lighting arrester is selected through following tests. Four 4/10 μs surge current tests and a repetitive charge transfer test (20 times criterion) are performed, and the repetitive charge transfer rating shall meet the 0.8 C requirement and variations of the lightning impact residual voltage shall not exceed 5%. A 2 ms square wave test (18 periods) is performed, and the square-wave current capacity shall meet the 600 A requirement. A test for obtaining the direct-current reference voltage under 1 mA and a test for obtaining the leakage current under three quarters of such direct-current reference voltage are combined to obtain the valve plate meeting the requirement on the leakage current. Thereby, the fabricated heavy-load high-current 10 kV lightning arrester is ensured to be qualified.

In step S102, a glass-epoxy layer and an electrode pair are assembled into a sealed shell inside which the target valve plate is disposed. The target valve plate is electrically connected to a first electrode and a second electrode in the electrode pair to form the heavy-load high-current 10 kV lightning arrester.

In an embodiment, the glass-epoxy layer, the electrode pair, and the target valve plate are assembled to form the high-current lightning arrester. After the high-current lightning arrester is installed and grounded, a circuit formed through the electrical connection among the target valve plate, the first electrode, and the second electrode is capable to ensure a surge current due to a lightning stroke. Thereby, a function of the lightning arrester can be implemented.

Herein the method for fabricating the high-current lightning arrester is provided according to technical solutions of the present disclosure. First, the direct-current reference voltage test is performed on the candidate valve plates to obtain the target valve plate. The target valve plate meets that the surge current capacity is greater than or equal to 100 kA, the square-wave current capacity is greater than 600 A, the residual voltage under 10 kA surge current is less than or equal to 45 kV, and the repetitive charge transfer rating is greater than or equal to 0.8 C. A combined surge-current test is performed on the valve plate of the lightning arrester according to the international standard IEC 60099-4:2014, and the valve plate shall pass the combined surge-current test, i.e., 4/10 μs surge current capacity under 100 kA, 8/20 μs lightning impact residual voltage under 40 kA, 2 ms square-wave current capacity under 600 A, and 8/20 μs lightning impact residual voltage under 40 kA. Thereby, the to-be-assembled valve plate is selected. The glass-epoxy layer and the electrode pair are assembled into the sealed shell, and the valve plate is disposed inside the sealed shell. The target valve plate is electrically connected to the first electrode and the second electrode in the electrode pair to form the heavy-load high-current 10 kV lightning arrester. In such method, the manufactured heavy-load high-current 10 kV lightning arrester is considered to qualified only when meeting the following requirements. Four 4/10 μs surge current tests and a repetitive charge transfer test (20 times criterion) are performed, and the repetitive charge transfer rating shall meet the 0.8 C requirement and variations of the lightning impact residual voltage shall not exceed 5%. A 2 ms square wave test (18 periods) is performed, and the square-wave current capacity shall meet the 600 A requirement. The lightning arrester shall further pass a bending load test under 400N for 18 seconds without being damaged. Moreover, the heavy-load high-current 10 kV lightning arrester dissipates heat, which is generated by the target valve plate, via the glass-epoxy layer. High heat conduction efficiency of the glass-epoxy improves surge endurance of the lightning arrester against the lightning strokes. A fault rate is reduced, and the issue of frequent faults of lightning arresters in conventional technology is addressed.

In an embodiment, the step S101 comprises following steps S1011 to S1015, which ensures safety of the lightning arrester.

In step S1011, the target valve plate is connected to a third electrode and a fourth electrode, where the fourth electrode is grounded.

In step S1012, a direct-current voltage is applied on the third electrode, and the leakage current is measured to obtain a first leakage current.

In step S1013, the direct-current voltage is adjusted until the leakage current reaches 1 mA to obtain a direct-current reference voltage. The direct-current reference voltage refers to the direct-current reference voltage when the first leakage current is equal to 1 mA.

In step S1014, three quarters of the direct-current reference voltage is applied the third electrode, and the leakage current is measured to obtain a second leakage current.

In step S1015, the target valve plate is determined to be qualified in response to the second leakage current being less than 50 μA.

In an embodiment, a surface of a core component is wiped by using lineless paper absorbing a small amount of absolute ethyl alcohol, then the whole core component with the adjusted voltage is carefully transported onto a test bed, and a testing high-voltage electrode is placed at a top of the core component. The direct-current reference voltage and the leakage current under three quarters of the reference voltage are referenced to ensure that a direct-current voltage is within a required range. For example, the direct-current voltage is less than 1.15 times the direct-current reference voltage. The target valve plate is determined to be qualified when its leakage current less than 50 μA under three quarters of the reference voltage. Otherwise it is determined to be unqualified, and another target valve plate shall be selected.

In an embodiment, the step S102 comprises following steps S1021 to S1026, which ensures a tight structure of the lightning arrester.

In step S1021, the glass-epoxy layer, the electrode pair, and the target valve plate are assembled into a core component. The target valve plate is connected to the second electrode and the first electrode, and the glass-epoxy layer is in contact with the target valve plate.

In step S1022, the core component is coated with a coupling agent and then dried.

In step S1023, the dried core component is preheated to obtain a preheated core component.

In step S1024, an outer sleeve mold of the preheated core component is obtained through vulcanizing. The vulcanizing is tested and meets a temperature requirement on the outer sleeve mold.

In step S1025, a silicone rubber is laid at an inner surface of the outer sleeve mold, and the silicone rubber at the inner surface of the outer sleeve mold is attached to the preheated core component through pressure molding, to obtain an outer sleeve made of the silicone rubber.

In step S1026, the outer sleeve and the preheated core component are sealed to form the heavy-load high-current 10 kV lightning arrester.

In an embodiment, the core component is placed and rolls in a container that contains the coupling agent, and it is ensured that the coating is uniform. Then, the core component is dried. Afterwards, the core component is disposed in an oven for the preheating and then disposed in a machine for the vulcanizing. First, a thermometer is utilized to detect whether a temperature of a mold cavity meets a criterion, where testing locations are center points of joint surfaces at two sides of a mold and an edge along a parting line direction. It is required that the tested temperature of the center points of the joint surfaces are within 150±5° C., the tested temperature at the edge along the parting line direction is not lower than that of the center points minus 10° C., and a temperature difference between corresponding points of an upper part and a lower part of the mold is within ±10° C. When vulcanizing the mold, the rubber material is first laid in a cavity formed by the lower part of the mold cavity in a center-aligned manner, and the rubber material is manually pressed downwards to form a U-shape in the cavity. Then, the core component is placed in the mold cavity on the laid the rubber material, and it is ensured that a member for positioning the core component coordinates with a blocking plate for positioning the mold. Then, another piece of the rubber material is laid on the core component, and the rubber material is pressed tightly against the core component. A switched is turned on to start shaping the mold through vulcanization, and then a product is ejected from the mold and disposed on a cooling bed. Extra waste materials exceeding two sides of the upper part and the lower part of the mold are removed through a plaster shovel. Thereby, the lightning arrester having a compact structure is formed, which avoids displacement of components. In addition, a high-strength glass-epoxy cylinder suitable for the vulcanizing is utilized for forming a composite outer sleeve of the lightning arrester, and the silicone rubber is molded and shaped under high temperature. The silicone rubber compound for molding should be suitable for the vulcanization and have good electrical and mechanical properties. A structural control agent, a reinforcing filler, and a fabrication process are adjusted for the rubber compound, such that the rubber can have excellent fluidity under high temperature, excellent thermal aging resistance, and excellent mechanical electrical performances. The epoxy cylinder and the outer sleeve made of the silicone rubber are bonded via a silane coupling agent, so that the sleeve and the epoxy cylinder are integrated when forming the heavy-load high-current 10 kV lightning arrester.

In addition, such outer sleeve is configured to protect an internal structure of the lightning arrester against damages. The outer sleeve is determined to be qualified when the whole structure can endure a bending load test under 400N for 18 seconds without being damaged.

IN an optional embodiment, the step S1021 comprises following step S10211 and step S10212, which implements a lightning protection function.

In step S10211, the target valve plate is mounted in a cavity enclosed by a glass-epoxy cylinder. The glass-epoxy layer is shaped into the glass-epoxy cylinder.

In step S10212, the first electrode and the second electrode are mounted on two opposite side walls, respectively, of the glass-epoxy cylinder to connect the target valve plate to the second electrode and the first electrode to form the core component.

In an embodiment, the glass-epoxy layer which is cylindrical forms a skeleton of the core component. Since its high strength is suitable for the molding, the first electrode and the second electrode are mounted on the two opposite side walls, respectively, of the glass-epoxy cylinder, and the target valve plate is connected to the second electrode and the first electrode. A contact pretension force is enhanced, and the electrodes at both sides are tightened to form the core component capable of lightning protection.

In an embodiment, the step S1026 comprises a following step S10261, which reduces a fault rate.

In step S10261, the first electrode and the second electrode are connected to the glass-epoxy cylinder through screw threads, an adhesive curable under room-temperature is applied onto the screw threads at a position of the connection, and a sealing ring is disposed on a contact surface between the electrode pair and the glass-epoxy layer, to form the sealed shell. Thereby, the sealed shell and the target valve plate form the heavy-load high-current 10 kV lightning arrester.

The southern China is somewhat humid, and incompletely statistics show that 70% of lightning arrester accidents is due to poor sealing performance. The lightning arrester of specification YH10W-17/45 adopts a double sealing structure. That is, the target valve plate is disposed into the high-strength glass-epoxy cylinder, d the upper electrode and the lower electrode of the core component are connected through the screw threads, the room-temperature curable adhesive is applied onto the connection position of the screw threads, and the contact surfaces between the upper electrode and the lower electrode, respectively, and the insulating cylinder are sealed by additional ethylene-propylene-diene monomer sealing rings, such that the double sealing is implemented. Thereby, substances such as moisture and air are prevented from entering the high-current lightning arrester, causing internal pollution and corrosion, and finally causing malfunctions. A service life of the heavy-load high-current 10 kV lightning arrester is prolonged, and the fault rate is reduced.

In an embodiment, after the step S1026, the method further comprises steps S201 to S204, which further reduces the fault rate.

In step S201, a test for obtaining a direct-current reference voltage and a leakage current is performed on the heavy-load high-current 10 kV lightning arrester to obtain an initial direct-current reference voltage and an initial leakage current. The initial leakage current is the leakage current of the heavy-load high-current 10 kV lightning arrester under three quarters of the initial direct-current reference voltage.

In step S202, the heavy-load high-current 10 kV lightning arrester is boiled in salty water for predetermined duration to obtain a to-be-tested heavy-load high-current 10 kV lightning arrester.

In step S203, a test for obtaining the direct-current reference voltage, the leakage current, and magnitude of partial discharge is performed on the to-be-tested heavy-load high-current 10 kV lightning arrester to obtain a to-be-verified direct-current reference voltage, a to-be-verified leakage current, and a partial discharge measurement. The to-be-verified leakage current is the leakage current of the to-be-tested heavy-load high-current 10 kV lightning arrester under three quarters of the initial direct-current reference voltage, and the partial discharge measurement is the magnitude of partial discharge of the to-be-tested heavy-load high-current 10 kV lightning arrester under 1.05 times of the initial direct-current reference voltage.

In step S204, the sealing is determined to be successful, in response to a first deviation being less than or equal to 5% of the initial direct-current reference voltage, a second deviation being less than or equal to 20 μA, and the magnitude of partial discharge being less than or equal to 10 pC. The first deviation is an absolute difference between the initial direct-current reference voltage and the to-be-verified direct-current reference voltage, and the second deviation is an absolute difference between the to-be-verified leakage current and the initial leakage current.

In an embodiment, when the heavy-load high-current 10 kV lightning arrester is subject to the water-boiling sealing test, the lightning arrester is boiled in water containing 0.1% NaCl for 42 hours. After the boiling, the determination is based on: 1) whether the deviation between the current direct-current reference voltage and the initial direct-current reference voltage does not exceed 5%, 2) whether the leakage current under three quarters of the direct-current reference voltage varies by no more than 20 μA with respect to the initial measurement, and 3) whether the partial discharge measurement does not exceed 10pC under 1.05 times continuous operation voltage Uc.

In addition, a thickness of the composite outer sleeve made of the silicone rubber of the lightning arrester when being integrally vulcanized is increased from original 3.5 mm to 5.0 mm, which addresses an aging issue of the outer sleeve.

In an embodiment, after step S10211 and before step S10212, the method further comprises step S201, which further reduce the fault rate.

In step S201, a conical spring is mounted between a target side wall and the target valve plate. The conical spring is configured to hold the valve plate through elastic force, and the target side wall is a side wall on which the first electrode is mounted.

In an embodiment, the conical spring, also known as a cone-shaped spring, is disposed between the first electrode and the target valve plate, such that a contact pretension force is enhanced to press the target valve plate tightly and prevent the target valve plate from waggling and being dislocated. Thereby, faults are prevented in the structure. In addition, an aluminum buffer block may be disposed between the conical spring and the target valve plate to prevent the pretension force from damaging the target valve plate.

In an embodiment, the conical spring is electrically conductive, which further reduces the fault rate.

The electrically conductive conical spring is capable to transfer current from the first electrode to the target valve plate. Hence, conductivity is improved to prevent the lightning strokes from damaging the conical spring.

In an embodiment, after the step S201, the method further comprises step S301 to further improve performances of the high-current lightning arrester.

In step S301, the conical spring are wrapped by using multiple conductive strips.

In an embodiment, electrical conductivity of the conical spring may not meet a requirement on the current capacity with respect to the lightning strokes. Four conductive bands may be utilized to wrap the conical spring to improve the current capacity. Thereby, it is avoided that the conical spring is damaged by the lightning current, and the 2 ms square-wave current capacity may be high enough for reaching 600 A.

In an embodiment, after the step S10261, the method further includes step S401, which further improves heat dissipation capability of the high-current lightning arrester.

In step S401, multiple protrusions are provided on the sealed shell.

In an embodiment, the multiple protrusions are arranged on a surface of the outer sleeve.

Thereby, a contact area with air is increased. That is, a heat dissipation area is increased to improve efficiency of heat dissipation.

In an embodiment, the target valve plate comprises at least one valve plate, of which a specification is D52 (of which a diameter is 52 mm), which further improves performances of the high-current lightning arrester.

In an embodiment, on a basis of the requirement on the lightning arrester, a varistor plate having a size of φ52*28 is invented for withstanding repeated lightning surge current and strong lightning surge current. The resistor plate has large surge current capacity (e.g., 100 kA), large square-wave current capacity (e.g., 600 A), low residual voltage (e.g., not greater than 45 kV under 8/20 μs 10 kA current), and large repetitive charge transfer capability (e.g., Qrs=0.8 C). A combined surge-current test is performed on the varistor plate according to the international standard IEC 60099-4:2014, and the varistor plate passes the combined surge-current test, i.e., 4/10 μs surge current capacity under 100 kA, 8/20 μs lightning impact residual voltage under 40 kA, 2 ms square-wave current capacity under 600 A, and 8/20 μs lightning impact residual voltage under 40 kA. Thereby, the performances of the heavy-load high-current 10 kV lightning arrester are improved, and the fault rate is reduced.

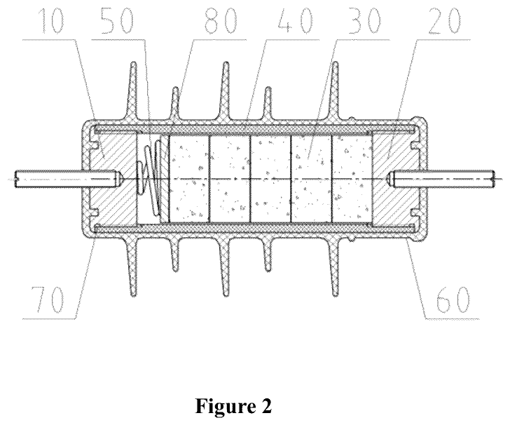

A high-current lightning arrester is further provided according to an embodiment of the present disclosure. Reference is made to FIG. 2, which is a schematic structural diagram of a high-current lightning arrester according to an embodiment of the present disclosure. The high-current lightning arrester with high peak current comprises an electrode pair, a valve plate 30, and a glass-epoxy layer 40. The electrode pair comprises a first electrode 10 and a second electrode 20. The valve plate 30 is connected to the second electrode 20 and a conical spring 50, and the valve plate 30 is configured to convert energy of a lightning stroke current into heat. The glass-epoxy layer 40 is in contact with the valve plate 30, and the glass-epoxy layer 40 is configured to dissipate the heat through thermal conduction.

The heavy-load high current lightning arrester comprise the electrode pair, the valve plate, and the glass-epoxy layer. The electrode pair comprises the first electrode and the second electrode. The valve plate is connected with the second electrode and the aluminum buffer block, and the valve plate is configured to converting energy of a lightning stroke current into heat. The glass-epoxy layer is in contact with the valve plate, and the glass-epoxy layer is configured to dissipate the heat through thermal conduction. In the high-current lightning arrester, the heat generated by the valve plate is dissipated via the glass-epoxy layer. High thermal conduction efficiency of the glass-epoxy improves endurance of the lightning arrester against the lightning surge current. The fault rate is reduced, and the issue of frequent faults of lightning arresters in conventional technology is addressed.

In an embodiment, the glass-epoxy layer is shaped into a cylinder and surrounds the valve plate, which further reduces the fault rate.

In an embodiment, the cylindrical glass-epoxy layer is a glass-epoxy cylinder. The high-strength glass-epoxy cylinder serves as a pressure release port of the lightning arrester and is capable to release a pressure normally when the lightning arrester malfunctions, which prevents the lightning arrester from smashing. The high-strength glass-epoxy cylinder increases a strength of the lightning arrester against tensile forces and bending forces.

Reference is made to FIG. 2. In an embodiment, the high-current lightning arrester further comprises a conical spring 50 disposed between the first electrode 10 and the aluminum buffer block 80. The conical spring 50 is configured to hold the valve plate 30 through elastic force, and the conical spring 50 is electrically conductive.

The conical spring is also known as a cone-shaped spring. As shown in FIG. 2, the conical spring is disposed between the first electrode 10 and the aluminum buffer block 80, such that a contact pretension force is enhanced to press the target valve plate tightly and prevent the target valve plate from waggling and being dislocated. Thereby, faults are prevented in the structure. Moreover, the electrically conductive conical spring 50 is capable to transfer current from the first electrode to the target valve plate 30.

In an embodiment, the high-current lightning arrester further comprises multiple conductive strips wrapping the conical spring, which further improves performances of the high-current lightning arrester.

In an embodiment, electrical conductivity of the conical spring may not meet a requirement on the current capacity with respect to the lightning strokes. Four conductive bands may be utilized to wrap the conical spring to improve the current capacity. Thereby, it is avoided that the conical spring is damaged by the lightning current, and the 2 ms square-wave current capacity may be high enough for reaching 600 A.

Reference is made to FIG. 2. In an embodiment, the high-current lightning arrester further comprises an outer sleeve 60 surrounding the glass-epoxy layer 40 and the electrode pair, which improves safety of high-current lightning arrester.

In an embodiment, the outer sleeve and the glass-epoxy cylinder forms a composed outer sleeve, which prevents the high-current lightning arrester from being damaged under external forces. Hence, the safety of the high-current lightning arrester is ensured.

In an embodiment, multiple protrusions are arranged on a surface of the outer sleeve.

The multiple protrusions on the surface of the outer sleeve increase a contact area with air. That is, a heat dissipation area is increased to improve efficiency of heat dissipation.

In an embodiment, a material of the outer sleeve is a silicone rubber. The outer sleeve is fabricated through molding. Thereby, heat dissipation capability of the high-current lightning arrester is further improved.

In an embodiment, the silicone rubber is processed and shaped through high-temperature vulcanizing press to form the outer sleeve. The silicone rubber compound for the vulcanizing press is not only suitable for molding but also has excellent electrical and mechanical properties, and a molding process is simple.

In an embodiment, the electrode pair and the outer sleeve are connected through screw threads, and a cured adhesive is provided a connection position of the screw threads. Thereby, structural stability of the high-current lightning arrester is further improved.

In an embodiment, the first electrode and the second electrode are both connected through the screw threads, and a room-temperature curable adhesive is applied onto the connection position of the screw threads to fix the first electrode and the second electrode and avoid detachment. Thereby, the structural stability of the high-current lightning arrester is improved. In addition, the cured adhesive is capable to fill gaps among the threads, which improves sealing performances greatly. Thereby, water vapor and dusts in the air are prevented from invading into the high-current lightning arrester and affecting a performance of the lightning arrester.

Reference is made to FIG. 2. In an embodiment, the high-current lightning arrester further comprises an ethylene-propylene-diene monomer (EPDM) sealing ring 70 disposed on a contact surface between the electrode pir and the glass-epoxy layer 40. Thereby, the sealing performances of the high-current lightning arrester are further improved.

The EPDM sealing ring, which is on the contact surface between the electrode pair and the glass-epoxy cylinder, and the cured adhesive provides double sealing, which further improves the sealing performances. Thereby, it is ensured that water vapor and dusts in the air do not invade into the heavy-load high-current lightning arrester and affect a performance of the lightning arrester.

The heavy-load high-current lightning arrester meets the requirement of 100 kA surge current capacity after four corresponding tests and 0.8 C repetitive charge transfer rating (20 times criterion). A combined surge-current test is performed on the invented valve plate according to the international standard IEC 60099-4:2014. The valve plate passes the combined surge-current test, i.e., 4/10 μs surge current capacity under 100 kA, 8/20 μs lightning impact residual voltage under 40 kA, 2 ms square-wave current capacity under 600 A, and 8/20 μs lightning impact residual voltage under 40 kA, and further has excellent heat dissipation capability. Compared with conventional lightning arresters, the lightning arrester has a simpler structure, lower labor cost in assembling, higher cost performance, more compact design, higher mechanical performances, higher antifouling capability, simpler installation, and no maintenance requirement. Hence, the lightning arrester can provide better protection and operate more smoothly, which enables a distribution network system to run effectively.

Moreover, the terms “comprise”, “include”, or any variant thereof are intended for encompassing non-exclusive inclusion, such that the process, method, article, or device comprising a series of elements comprises not only the series of elements but also elements that are not explicitly listed or that are inherent to such process, method, article, or device. Unless expressively limited otherwise, the statement “comprising (including) a . . . ” does not exclude that another identical element exists in the process, method, product or device.

On a basis of the foregoing description, following technical effects can be achieved in embodiments of the present disclosure.

1) The method for fabricating the high-current lightning arrester is provided according to technical solutions of the present disclosure. First, the direct-current reference voltage test is performed on the candidate valve plates to obtain the target valve plate. The target valve plate meets that the surge current capacity is greater than or equal to 100 kA, the square-wave current capacity is greater than 600 A, the residual voltage under 10 kA surge current is less than or equal to 45 kV, and the repetitive charge transfer rating is greater than or equal to 0.8 C. A combined surge-current test is performed on the valve plate of the lightning arrester according to the international standard IEC 60099-4:2014, and the valve plate shall pass the combined surge-current test, i.e., 4/10 μs surge current capacity under 100 kA, 8/20 μs lightning impact residual voltage under 40 kA, 2 ms square-wave current capacity under 600 A, and 8/20 μs lightning impact residual voltage under 40 kA. Thereby, the to-be-assembled valve plate is selected. The glass-epoxy layer and the electrode pair are assembled into the sealed shell, and the valve plate is disposed inside the sealed shell. The target valve plate is electrically connected to the first electrode and the second electrode in the electrode pair to form the heavy-load high-current 10 kV lightning arrester. In such method, the manufactured heavy-load high-current 10 kV lightning arrester is considered to qualified only when meeting the following requirements. Four 4/10 μs surge current tests and a repetitive charge transfer test (20 times criterion) are performed, and the repetitive charge transfer rating shall meet the 0.8 C requirement and variations of the lightning impact residual voltage shall not exceed 5%. A 2 ms square wave test (18 periods) is performed, and the square-wave current capacity shall meet the 600 A requirement. The lightning arrester shall further pass a bending load test under 400N for 18 seconds without being damaged. Moreover, the heavy-load high-current 10 kV lightning arrester dissipates heat, which is generated by the target valve plate, via the glass-epoxy layer. High heat conduction efficiency of the glass-epoxy improves surge endurance of the lightning arrester against the lightning strokes. A fault rate is reduced, and the issue of frequent faults of lightning arresters in conventional technology is addressed.

2) The heavy-load high current lightning arrester comprise the electrode pair, the valve plate, and the glass-epoxy layer. The electrode pair comprises the first electrode and the second electrode. The valve plate is connected with the second electrode and the aluminum buffer block, and the valve plate is configured to converting energy of a lightning stroke current into heat. The glass-epoxy layer is in contact with the valve plate, and the glass-epoxy layer is configured to dissipate the heat through thermal conduction. In the high-current lightning arrester, the heat generated by the valve plate is dissipated via the glass-epoxy layer. High thermal conduction efficiency of the glass-epoxy improves endurance of the lightning arrester against the lightning surge current. The fault rate is reduced, and the issue of frequent faults of lightning arresters in conventional technology is addressed.

The above embodiments are only preferrable embodiments of the present disclosure and are not intended for limiting the present disclosure. Those skilled in the art can make various modifications and variations to the embodiments of the present disclosure. Any modification, equivalent replacement, or improvement made within a principle of the present disclosure shall fall within a protection scope of the present disclosure.

1. A method for fabricating a lightning arrester, comprising:
obtaining a target valve plate from candidate valves through a direct-current reference-voltage test, wherein the target valve plate meets that:
a surge current capacity is greater than or equal to 100 kA,
a square-wave current capacity is greater than 600 A,
a residual voltage under 10 kA surge current is less than or equal to 45 kV, and
repetitive charge transfer rating is greater than or equal to 0.8 C; and
assembling a glass-epoxy layer and an electrode pair into a sealed shell inside which the target valve plate is disposed, wherein the target valve plate is electrically connected to a first electrode and a second electrode in the electrode pair to form the lightning arrester.

2. The method according to claim 1, wherein assembling the glass-epoxy layer and the electrode pair into the sealed shell inside which the target valve plate is disposed comprises:
assembling the glass-epoxy layer, the electrode pair, and the target valve plate into a core component, wherein the target valve plate is connected to the second electrode and the first electrode, and the glass-epoxy layer is in contact with the target valve plate;
coating the core component with a coupling agent and drying the coated core component;
preheating the coated and dried core component to obtain a preheated core component;
obtaining an outer sleeve mold of the preheated core component, wherein a temperature of the outer sleeve mold meets a requirement of vulcanizing a silicone rubber;
laying the silicone rubber at an inner surface of the outer sleeve mold, and attaching the silicone rubber at the inner surface of the outer sleeve mold to the preheated core component through pressure molding and the vulcanizing, to obtain an outer sleeve made of the silicone rubber; and
sealing the outer sleeve and the preheated core component to form the lightning arrester.

3. The method according to claim 2, wherein assembling the glass-epoxy layer, the electrode pair, and the target valve plate into the core component comprises:
mounting the target valve plate in a cavity enclosed by a glass-epoxy cylinder, wherein the glass-epoxy layer is shaped into the glass-epoxy cylinder; and
mounting the first electrode and the second electrode on two opposite side walls, respectively, of the glass-epoxy cylinder to connect the target valve plate to the second electrode and the first electrode to form the core component.

4. The method according to claim 2, wherein sealing the outer sleeve and the preheated core component to form the lightning arrester comprises:
connecting the first electrode and the second electrode to the glass-epoxy cylinder through screw threads;
applying an adhesive, which is curable under room-temperature, onto the screw threads at a position at which the first electrode and the second electrode are connected to the glass-epoxy cylinder; and
disposing a sealing ring on a contact surface between the electrode pair and the glass-epoxy layer,
to form the sealed shell.

5. The method according to claim 2, wherein after sealing the outer sleeve and the preheated core component to form the lightning arrester, the method further comprises:
testing the lightning arrester to obtain an initial direct-current reference voltage and an initial leakage current, wherein the initial leakage current is a leakage current of the lightning arrester under three quarters of the initial direct-current reference voltage;
boiling the lightning arrester in salty water for predetermined duration to obtain a to-be-tested lightning arrester;
testing the to-be-tested lightning arrester to obtain a to-be-verified direct-current reference voltage, a to-be-verified leakage current, and magnitude of partial discharge, wherein the to-be-verified leakage current is a leakage current of the to-be-tested lightning arrester under three quarters of the initial direct-current reference voltage, and the magnitude of partial discharge is measured under 1.05 times of the initial direct-current reference voltage; and
determining that the sealing is successful in response to: a first deviation being less than or equal to 5% of the initial direct-current reference voltage, a second deviation being less than or equal to 20 μA, and the magnitude of partial discharge being less than or equal to 10 pC, wherein the first deviation is an absolute difference between the initial direct-current reference voltage and the to-be-verified direct-current reference voltage, and the second deviation is an absolute difference between the to-be-verified leakage current and the initial leakage current.

6. The method according to claim 3, wherein after mounting the target valve plate in the cavity enclosed by the glass-epoxy cylinder and before mounting the first electrode and the second electrode on two opposite side walls, respectively, of the glass-epoxy cylinder, the method further comprises:
mounting a conical spring between a target side wall and the target valve plate, wherein the conical spring is configured to hold the valve plate through elastic force, and the target side wall is of the two opposite side walls, and the first electrode is mounted on the target side wall.

7. The method according to claim 6, wherein the conical spring is electrically conductive.

8. The method according to claim 6, wherein after mounting the conical spring between the target side wall and the target valve plate, the method further comprises:
wrapping the conical spring by using a plurality of conductive strips.

9. The method according to claim 4, wherein after sealing the outer sleeve and the preheated core component, the method further comprises:
providing a plurality of protrusions on the sealed shell.

10. The method according to claim 1, wherein the target valve plate comprises at least one valve plate, and a diameter of the at least one valve plate is equal to 52 mm.

11. A high-current lightning arrester, comprising:
an electrode pair, comprises a first electrode and a second electrode;
a valve plate, connected to the second electrode and a conical spring, wherein the valve plate is configured to convert energy of a lightning stroke current into heat; and
a glass-epoxy layer in contact with the valve plate, wherein the glass-epoxy layer is configured to dissipate the heat through thermal conduction.
